(19) United States
(12) Patent Application Publication
(10) Pub. No.: US 2008/0018694 A1
(43) Pub. Date: Jan. 24, 2008

(54) Methods for producing liquid-ejecting head, for checking quality thereof and for managing thickness of multilayered body thereof

(75) Inventor: Atsushi Ito, Nagoya-shi (JP)

Correspondence Address: Eugene LeDonne, Esq.;Reed Smith LLP, 29th Floor, 599 Lexington Avenue, New York, NY, 10022, US

(73) Assignee: Brother Kogyo Kabushiki Kaisha

(21) Appl. No.: 11/879,959

(22) Filed: Jul. 19, 2007

(30) Foreign Application Priority Data
Jul. 19, 2006 (JP) 2006-196816

(51) Int. Cl. B41J 2/01

(52) U.S. Cl. 347/20

(57) ABSTRACT

A method for managing a thickness of a multilayered body constituting a part of a liquid-ejecting head, wherein the liquid-ejecting head includes: (a) a liquid-channel unit formed of plate members laminated on each other with at least one adhesive layer each interposed between adjacent ones of the plate members, the liquid-channel unit including a liquid channel provided in an inside thereof and a nozzle provided in an outer surface thereof; and (b) an actuator fixed to the liquid-channel unit and operable to eject liquid from the nozzle, wherein the multilayered body constitutes at least a part of the liquid-channel unit, and includes plate members as at least a part of the plate members constituting the liquid-channel unit and at least one adhesive layer as at least a part of the at least one adhesive layer constituting the liquid-channel unit, and wherein the thickness of the multilayered body is managed to be not less than a sum of (i) a total thickness of the plate members constituting the multilayered body and (ii) a product in which a reference thickness as a minimum required thickness of one of the at least one adhesive layer is multiplied by a number of the at least one adhesive layer constituting the multilayered body.

### CROSS REFERENCE TO RELATED APPLICATION

The present application claims priority from Japanese Patent Application No. 2006-196816, which was filed on Jul. 19, 2006, the disclosure of which is herein incorporated by reference in its entirety.

### BACKGROUND OF THE INVENTION

1. Field of the Invention

The present invention relates to a liquid-ejecting head having a multilayered structure in which a plurality of plate members each having a part of a liquid channel formed thereon are laminated on and adhered to one another by adhesive, the liquid-ejecting head configured such that ink droplets or ink is ejected therefrom, owing to an actuator being driven and, more particularly, the present invention relates to methods for producing the liquid-ejecting head, for checking a quality thereof and for managing a thickness of a multilayered body thereof.

2. Discussion of Related Art

As an example of an apparatus using a liquid-ejecting head, there has been conventionally known an inkjet recording apparatus in which a recording is performed on a recording medium by reciprocating the liquid-ejecting head that ejects ink droplets or ink and that faces the recording medium. This liquid-ejecting head includes a cavity unit as a liquid-channel unit in which ink channels or liquid channels are formed, a piezoelectric actuator disposed adjacent to the cavity unit and a drive circuit for driving the piezoelectric actuator. The cavity unit includes a plurality of plates, e.g., a cavity plate, a manifold plate, a nozzle plate, etc. In the cavity plate, there are formed a plurality of pressure chambers for accommodating the ink. In the manifold plate, there are formed at least one common ink chamber for supplying the ink to each of the pressure chambers. In the nozzle plate, there are formed a plurality of nozzles each of which opens and each of which is connected to a corresponding one of the pressure chambers. An adhesive layer is interposed between every vertically adjacent two of the plates such that the every two plates are adhered to each other. The piezoelectric actuator driven by the drive circuit selectively applies an ejection pressure to the pressure chambers, whereby the ink (the ink droplets) is ejected, to the recording medium, from the nozzles each of which is connected to the corresponding one of the pressure chambers. The thus constructed inkjet recording apparatus is disclosed by a Patent Document 1 (JP-A-2005-96171), for instance.

### SUMMARY OF THE INVENTION

If an amount of the adhesive for adhering the plates is insufficient (i.e., insufficiency of the adhesive) when the cavity unit is produced, there may arise a situation in which different color inks are mixed with one another (i.e., ink mixture) because the ink channels communicate with one another (i.e., ink-channel communication). In a conventional method for producing the liquid-ejecting head, however, it is judged that the ink-channel communication has occurred due to the insufficiency of the adhesive occurred between some of the plates, only when the ink mixture is found out or detected in a printing test performed after the liquid-ejecting head is produced. This manner in the conventional method, therefore, problematically causes a delay in coping with a poor adhering in which the plates are incompletely or inadequately adhered to each other.

The present invention has been developed in view of the background discussed above. It is therefore an object of the present invention to provide methods for producing the liquid-ejecting head, for checking a quality thereof and for managing a thickness of a multilayered body thereof, which methods realize an early detection of an insufficiency of the adhesive occurred between some of plates constituting the liquid-ejecting head.

To achieve the above-described object, according to the present invention, there is adopted a method for managing a thickness of a multilayered body constituting a part of a liquid-ejecting head. In the method according to the present invention, the liquid-ejecting head includes: (a) a liquid-channel unit formed of a plurality of plate members which are laminated on each other with at least one adhesive layer each interposed between adjacent ones of the plurality of plate members, the liquid-channel unit including a liquid channel provided in an inside thereof and a nozzle provided in an outer surface thereof; and (b) an actuator fixed to the liquid-channel unit and operable to eject liquid droplets from the nozzle. Further, in the method according to the present invention, the multilayered body constitutes at least a part of the liquid-channel unit, and includes a plurality of plate members which are at least a part of the plurality of plate members constituting the liquid-channel unit and at least one adhesive layer which is at least a part of the at least one adhesive layer constituting the liquid-channel unit. Further, in the method according to the present invention, the thickness of the multilayered body is managed so as to be not less than a sum of (i) a total thickness of the plurality of plate members included in the multilayered body and (ii) a product in which a reference thickness as a minimum required thickness of one of the at least one adhesive layer is multiplied by a number of the at least one adhesive layer included in the multilayered body.

In a certain multilayered body, “B” represents a total thickness of plate members to be laminated. Further, “C” represents a reference thickness of an adhesive layer to be interposed between adjacent two of the plate members which have been laminated. “N” represents a number of the plate members which have been laminated. A total thickness of at least one of the adhesive layers each interposed between the corresponding two of the plate members which have been laminated can be obtained by a following formula: (N−1)×C. Therefore, a total thickness of the laminated plate members including the at least one adhesive layer, namely, a thickness of the multilayered body can be obtained by a following formula: B+(N−1)×C. Hence, if the thickness of the multilayered body actually measured is the same as, or larger than, the thickness thereof obtained by the above-indicated formula: B+(N−1)×C, it can be assumed that an average of the thickness of the at least one adhesive layer each interposed between adjacent two of the plate members constituting the above-indicated multilayered body is not less than the reference thickness “C”. In other words, where “A” represents the thickness of the multilayered body, the thickness of the multilayered body could be managed to satisfy a following formula: A≧B+(N−1)×C, thereby enabling a thickness of the each of the at least one adhesive layer to be not less than the reference thickness “C”. Therefore, in the methods according to the present invention for producing the liquid-ejecting head, for checking the quality thereof and for managing the thickness of the multilayered body thereof, it can be judged whether the thickness of the at least one adhesive layer (i.e., adhesive) each interposed between the adjacent ones of the plurality of plate members is appropriate even in the middle of producing the liquid-ejecting head, thereby realizing the early detection of the poor adhering.

### BRIEF DESCRIPTION OF THE DRAWINGS

The above and optional objects, features, and advantages of the present invention will be better understood by reading the following detailed description of preferred embodiment of the invention when considered in conjunction with the accompanying drawings, in which:

FIG. 1 is an explanatory plan view showing a primary construction of an inkjet recording apparatus;

FIG. 2 is a bottom plan view of a head holder as seen from a lower side thereof, showing a nozzle surface as a lower surface of the head holder;

FIG. 3 is a perspective view showing plate members constituting a liquid-ejecting head held by the head holder shown in FIG. 2;

FIG. 4 is an explanatory view partially showing a cross-section taken along a line A-A of the liquid-ejecting head held by the head holder shown in FIG. 2;

FIG. 5 is an explanatory view schematically showing a state in which the plate members constituting the liquid-ejecting head shown in FIG. 4 are laminated on each other via adhesive layers; and

FIG. 6 is a flow chart showing a method for producing the liquid-ejecting head.

### DETAILED DESCRIPTION OF THE PREFERRED EMBODIMENT

Hereinafter, there will be described methods for producing an ink-ejecting head 30 as a liquid-ejecting head provided in an inkjet recording apparatus 1, for checking a quality of the ink-ejecting head 30 and for managing a thickness of a multilayered body in a preferred embodiment of the present invention by reference to the drawings.

### [Primary Construction of Inkjet Recording Apparatus]

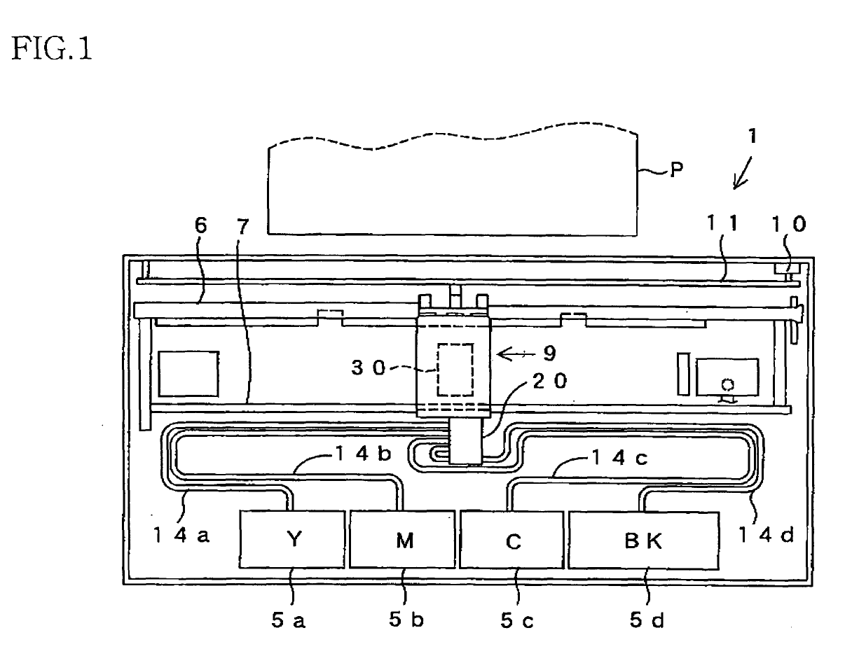

Initially, a primary construction of the inkjet recording apparatus 1 will be described, with reference to FIG. 1. FIG. 1 is an explanatory plan view showing the primary construction of the inkjet recording apparatus 1. In the inkjet recording apparatus 1, there are provided two guide rods 6, 7 by which a head holder 9 functioning as a carriage is slidably supported. The head holder 9 holds the ink-ejecting head 30 from which an ink is ejected onto a recording sheet P as a recording medium for performing a recording thereon. The head holder 9 is connected to an endless belt 11 to be turned by a carriage motor 10, and is slidably moved along the guide rods 6, 7 when the endless belt 11 is turned.

In the inkjet recording apparatus 1, there are provided ink tanks 5a, 5b, 5c, 5d for accommodating a yellow-colored ink, a magenta-colored ink, a cyan-colored ink and a black-colored ink, respectively (hereinafter, simply referred to as “a yellow ink”, “a magenta ink”, “a cyan ink” and “a black ink”, respectively). The ink tanks 5a-5d are connected to plastic ink-supply tubes 14a, 14b, 14c, 14d, respectively. Each ink supplied from a corresponding one of the ink-supply tubes 14a-14d is introduced into the ink-ejecting head 30 via a tube joint 20 extending frontward from the head holder 9. There may be used a pigment-type ink or a dye-type ink as each ink.

### [Construction of Ink-Ejecting Head]

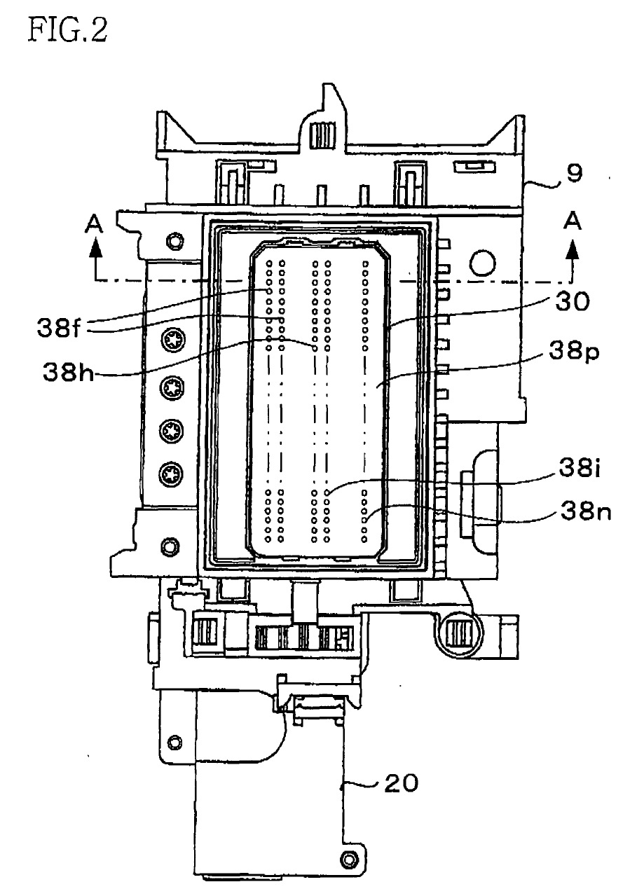

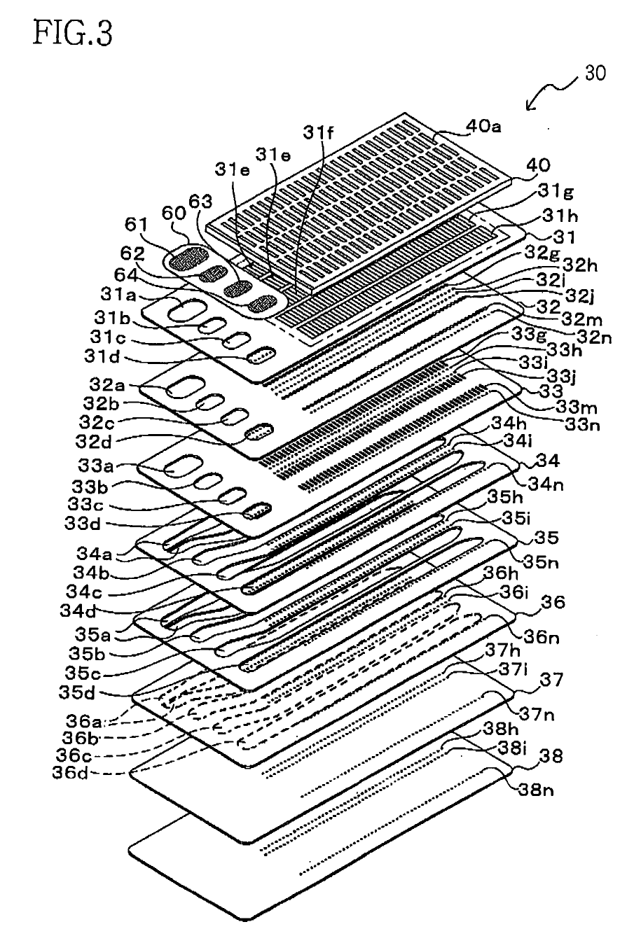

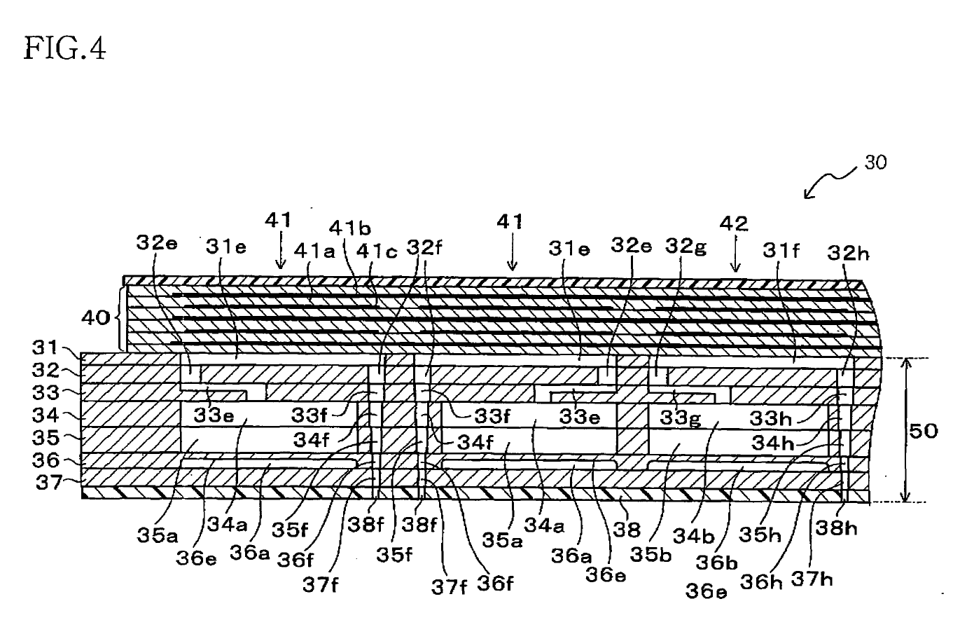

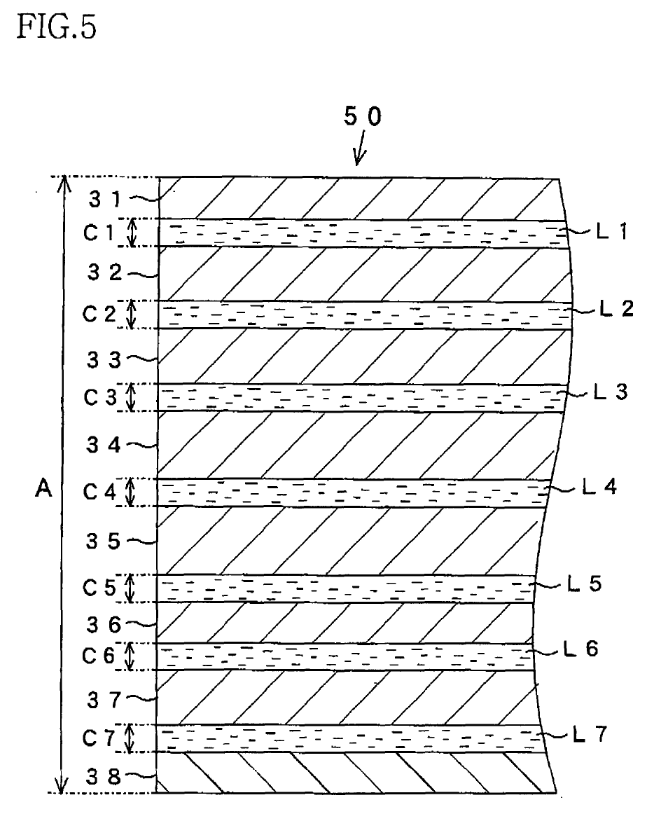

Next, there will be described a construction of the ink-ejecting head 30, with reference to FIGS. 2 and 5. FIG. 2 is a bottom plan view of a head holder 9 as seen from a lower side thereof, showing a nozzle surface 38p as a lower surface of the head holder 9. FIG. 3 is a perspective view showing plate members constituting the ink-ejecting head 30 held by the head holder 9 shown in FIG. 2. FIG. 4 is an explanatory view partially showing a cross-section taken along a line A-A of the ink-ejecting head 30 held by the head holder 9 shown in FIG. 2. FIG. 5 is an explanatory view schematically showing a state in which the plate members constituting the ink-ejecting head 30 shown in FIG. 4 are laminated on each other via adhesive layers. It is noted that, in the description below, a downward direction is defined by a direction in which the ink is ejected toward the recording sheet P.

As shown in FIG. 2, on a lower surface of the ink-ejecting head 30, i.e., on the nozzle surface 38p, there are provided groups of nozzles 38f, 38h, 38i, 38n for ejecting the black ink, the yellow ink, the cyan ink and the magenta ink, respectively, such that the nozzles 38f-38n constituting each groups is disposed in at least one row extending in a direction perpendicular to a direction (i.e., a main scanning direction) in which the head holder 9 is moved. Each of the nozzles 38f-38n opens downward so as to face an upper surface of the recording sheet P as the recording medium (shown in FIG. 1),

As shown in FIG. 4, the ink-ejecting head 30 has a construction in which a lower surface of a piezoelectric actuator 40 is adhered or bonded to an upper surface of a cavity unit 50. As shown in FIG. 3, the cavity unit 50, i.e., a liquid-channel unit, has a multilayered structure formed of eight thin plate members which are laminated on and adhered to each other. More specifically, the eight thin plate members include a nozzle plate 38, a spacer plate 37, a damper plate 36, manifold plates 34, 35, a supply plate 33, a base plate 32 and a cavity plate 31, as laminated from a bottom side to an upper side (of the cavity unit 50) in a described order. Each of the plates 31-38 has a thickness of 50 μm-150 μm. The nozzle plate 38 is made of a synthetic resin such as a polyimide, and the other plates 31-37 are made of a metal such as a 42 alloy steel (i.e., an alloy steel containing a nickel at 42%). As shown in FIG. 5, the plates 31-38 are adhered to one another by adhesive layers L1-L7. In the present embodiment, each of the adhesive layers L1-L7 is formed by an application or a transfer of a thermosetting epoxy resin, for instance.

The piezoelectric actuator 40 includes active portions 41, 41 and active portions 42 for generating energy for ejecting the black ink and the yellow ink, respectively. Indeed, although omitted from FIG. 4, there are disposed, in a right side of the active portions 42, active portions for generating energy for ejecting the cyan ink and, further in a right side, active portions for generating energy for ejecting the magenta ink. It is noted that, throughout the description, the active portions are defined by portions of the piezoelectric actuator 40 which are displaced for applying a pressure (i.e., an ejection pressure) to the inks accommodated in respective pressure chambers 31e, 31f, 31g, 31h (which will be described later) for ejecting the inks.

The piezoelectric actuator 40 has a construction in which piezoelectric sheets (which are made of a piezoelectric material) and film-like electrodes are alternately laminated. Each of the active portions 41 is defined by a portion 41a of the piezoelectric sheet vertically interposed between electrodes 41b and 41c. The other active portions are defined in a similar manner as the active portion 41. In the cavity plate 31, there are formed, below the active portions, a plurality of the pressure chambers 31e, 31f, 31g, 31h. More specifically, in the cavity plate 31, there are formed, below a plurality of the active portions 41, the pressure chambers 31e which are arranged in rows for applying the ejection pressure to the black ink. Similarly, in the cavity plate 31, there are formed, below a plurality of the active portions 42, the pressure chambers 31f which are arranged in row for applying the ejection pressure to the yellow ink. Below the other active portions, there are formed the pressure chambers 31g and the pressure chambers 31h for applying the ejection pressure to the cyan ink and the magenta ink, respectively. The pressure chambers 31g and the pressure chambers 31h are arranged in two rows, respectively.

As shown in FIG. 3, in the manifold plates 34, 35, there are formed, below the rows of the pressure chambers 31e-31h, common ink chambers 34a, 34b, 34c, 34d and 35a, 35b, 35c, 35d which extend in almost the same length as the length of rows of the pressure chambers 31e-31h for supplying the inks thereto. More specifically, in the manifold plates 34, 35, there are formed, below the rows of the pressure chambers 31e, the common ink chambers 34a, 35a for accommodating the black ink Below the row of the pressure chambers 31f, there are formed the common ink chambers 34b, 35b for accommodating the yellow ink. Below the row of the pressure chambers 31h, there are formed the common ink chambers 34c, 35c for accommodating the cyan ink. Below the row of the pressure chambers 31h, there are formed the common ink chambers 34d, 35d for accommodating the magenta ink.

In the supply plate 33 disposed over the common ink chambers 34a-34d, there are formed narrow portions 33e, 33g, 33j, 33m each of which corresponds to one of the pressure chambers 31e-31h. Each of the narrow portions 33e-33m has a shape like a recess formed along a flat upper surface of the supply plate 33. Each of the narrow portions 33e-33m is in communication, at one of ends thereof from which the ink flows in, with a corresponding one of the common ink chambers 34a-34d, 35a-35d via a communication hole vertically formed through the supply plate 33. On the supply plate 33, there is superposed the base plate 32 which covers an opening (which elongates in its longitudinal direction) of each of the narrow portions 33e-33m. Each of the narrow portions 33e-33m is in communication, at the other of the ends thereof from which the ink flows out, with a corresponding one of the pressure chambers 3ie-31h via a corresponding one of communication holes 32e, 32g, 32j, 32m each of which is vertically formed through the base plate 32.

A vertical cross-sectional area of each of the narrow portions 33e-33m is smaller than a vertical cross-sectional area of the corresponding one of the pressure chambers 31e-31h. Resistance against an ink flow is larger in the narrow portions 33e-33m than in the common ink chambers 34a-34d, 35a-35d and the pressure chambers 31e-31h. That is, each of the narrow portions 33e-33m functions as a reducer for a component of a pressure fluctuation toward the common ink chambers 34a-34d, 35a-35d, which pressure fluctuation generated in the pressure chambers 31e-31h (each of which is in communication with the corresponding one of the narrow portions 33e-33m).

On a lower surface of the damper plate 36, there are formed, at positions corresponding to the common ink chambers 34a-34d, 35a-35d, respectively, damper chambers 36a, 36b, 36c, 36d, each of which opens downward. A horizontal cross-sectional area of each of the damper chambers 36a-36d is almost the sane as a horizontal cross-sectional area of a lower surface of the corresponding one of the common ink chambers 34a-34d, 35a-35d (which are provided adjacent to the damper plate 36).

The damper plate 36 is made of an elastically deformable material, e.g., a metal, etc. Each of bottom plate portions 36e has a thin plate-like construction and defines an upper side of a corresponding one of the damper chambers 36a-36d. Further, each of the bottom plate portions 36e is capable of warping or vibrating freely toward the common ink chambers 34a -34d, 35a-35d and toward the damper chambers 36a-36d. Upon ejecting the ink, if the pressure fluctuation generated in any one of the pressure chambers 31e-31h is propagated to the common ink chambers 34a-34d, 35a-35d, the pressure fluctuation is absorbed and reduced, namely, a damper effect is exhibited, owing to a corresponding one of the bottom plate portions 36e warping or vibrating by its elastic deformation. Further, the above-described arrangement of the bottom plate portions 36e effectively prevents a cross talk in which the pressure fluctuation is propagated to the other pressure chambers 31e-31h.

Through the plates 32-37 interposed between the cavity plate 31 and the nozzle plate 38, there are vertically formed through holes 32f-37f, 32h-37h, 32i-37i, 32n-37n, respectively. The through holes designated with same alphabet vertically communicate with each other in the numeric order as seen from the top to the bottom (32f to 37f/32h to 37h/32i to 37i/32n to 37n). Further, the through holes 32f-37f, 32h-37h, 32i-37i, 32n-37n are provided for introducing the black ink in the pressure chambers 31e to the nozzles 38f, the yellow ink in the pressure chambers 31f to the nozzles 38h, the cyan ink in the pressure chambers 31g to the nozzles 38i, the magenta ink in the pressure chambers 31h to the nozzles 38n, respectively.

As is clear from the forgoing description, liquid channels are provided in an inside of the cavity unit 50 (i.e., the liquid-channel unit), owing to the above-described construction. More specifically, one of the liquid channels is constituted by a corresponding one of the common ink chambers 34a-34d, 35a-35d, a corresponding one of the narrow portions 33e-33m, the corresponding one of the communication holes 32e-32m, the corresponding one of the pressure chambers 31e-31h, a corresponding one set of the through holes 32f-37f, 32h-37h, 32i-37i, 32n-37n, etc.

The head holder 9 includes relay tanks (not shown) each having a relay ink-chamber (not shown) for storing air bubbles contained in the ink supplied from the ink tank 5a-5d (shown in FIG. 1). As shown in FIG. 3, through the cavity plate 31, the base plate 32 and the supply plate 33, there are vertically formed ink inlets 31a-31d, 32a-32d and 33a-33d, respectively, for supplying the each ink supplied from a corresponding one of the relay tanks to the corresponding one of the common ink chambers 34a-34d, 35a-35d. The ink inlets designated with same alphabet vertically communicate with each other in the numeric order as seen from the top to the bottom (31a to 33a/31b to 33b/31c to 33c/31d to 33d). The ink inlets 31a-31d formed through the cavity plate 31 are covered by a filter member 60 having filters 61-64 for filtering out foreign objects contained in the each ink.

### [Methods for Checking Quality of Ink-Ejecting Head and for Managing Thickness of Multilayered Body Thereof]

Next, there will be described methods for checking a quality of the ink-ejecting head 30 and for managing a thickness of a multilayered body thereof. It is noted that, in the following description, there will be used a term, i.e., the multilayered body. The multilayered body constitutes a part of the ink-ejecting head 30. More specifically, the multilayered body constitutes at least a part of the cavity unit 50, and includes a plurality of the plates which are at least a part of the plates 31-38 constituting the cavity unit 50 and at least one adhesive layer which is at least a part of the adhesive layers L1-L7 constituting the cavity unit 50.

As shown in FIG. 5, a lower surface of the cavity plate 31 and an upper surface of the base plate 32 are adhered by an adhesive layer L1 having a thickness of C1. A lower surface of the base plate 32 and an upper surface of the supply plate 33 are adhered by an adhesive layer L2 having a thickness of C2. A lower surface of the supply plate 33 and an upper surface of the manifold plate 34 are adhered by an adhesive layer L3 having a thickness of C3. A lower surface of the manifold plate 34 and an upper surface of the manifold plate 35 are adhered by an adhesive layer L4 having a thickness of C4. A lower surface of the manifold plate 35 and an upper surface of the damper plate 36 are adhered by an adhesive layer L5 having a thickness of C5. A lower surface of the damper plate 36 and an upper surface of the spacer plate 37 are adhered by an adhesive layer L6 having a thickness of C6. A lower surface of the spacer plate 37 and an upper surface of the nozzle plate 38 are adhered by an adhesive layer L7 having a thickness of C7.

In a certain multilayered body, “B” represents a total thickness of plate members to be laminated. “C” represents a reference thickness of an adhesive layer to be interposed between adjacent two of the plate members which have been laminated. “N” represents a number of the plate members which have been laminated. A total thickness of at least one of the adhesive layers each interposed between the corresponding two of the plate members which have been laminated can be obtained by a following formula: (N−1)×C. Therefore, a total thickness of the laminated plate members including the at least one adhesive layer, namely, a thickness of the multilayered body can be obtained by a following formula: B+(N−1)×C.

Hence, if the thickness of the multilayered body actually measured is the same as, or larger than, the thickness thereof obtained by the above-indicated formula: B+(N−1)×C, it can be assumed that an average of the thickness of the at least one adhesive layer each interposed between adjacent two of the plate members constituting the above-indicated multilayered body is not less than the reference thickness “C”. In other words, where “A” represents the thickness of the multilayered body as a management thickness, a thickness of the cavity unit 50 should be managed to satisfy the following formula: A≧B+(N−1)×C, thereby enabling a thickness of each of the at least one adhesive layer to be not less than the reference thickness “C”. Further, the quality of the ink-ejecting head 30 can be checked if the reference thickness “C” is set as the minimum required thickness of each of the at least one adhesive layer.

Where the cavity unit 50 is considered as the multilayered body, for example, the total thickness “B” of the plate members 31-38 of the cavity unit 50 is set as 740 μm and the reference thickness “C” of one of the adhesive layers L1-L7 is set as 1 μm. By referring to the cavity unit 50 shown in FIG. 5, since the number “N” of the plate members is eight, the thickness of the cavity unit 50 is obtained as follows: B+(N−1)×C=740 μm+(8−1)×1 μm=747 μm. For instance, where an actual thickness “A” of the cavity unit 50 is 745 μm, the average of the thicknesses C1-C7 of the adhesive layers L1-L7 is obtained as follows: (745 μm−740 μm)/7≈0.71 μm. Therefore, it can be assumed that the thickness of each of the adhesive layers L1-L7 is less than 1 μm. On the contrary, where the actual thickness “A” of the cavity unit 50 is 750 μm, the average of the thicknesses C1-C7 of the adhesive layers L1-L7 is obtained as follows: (750 μm−740 μm)/7≈1.43 μm. Therefore, it can be assumed that the thickness of each of the adhesive layers L1-L7 is not less than 1 μm. In other words, it can be assumed that there are no adhesive layers having a thickness less than 1 μm.

### [Method for Producing Ink-Ejecting Head]

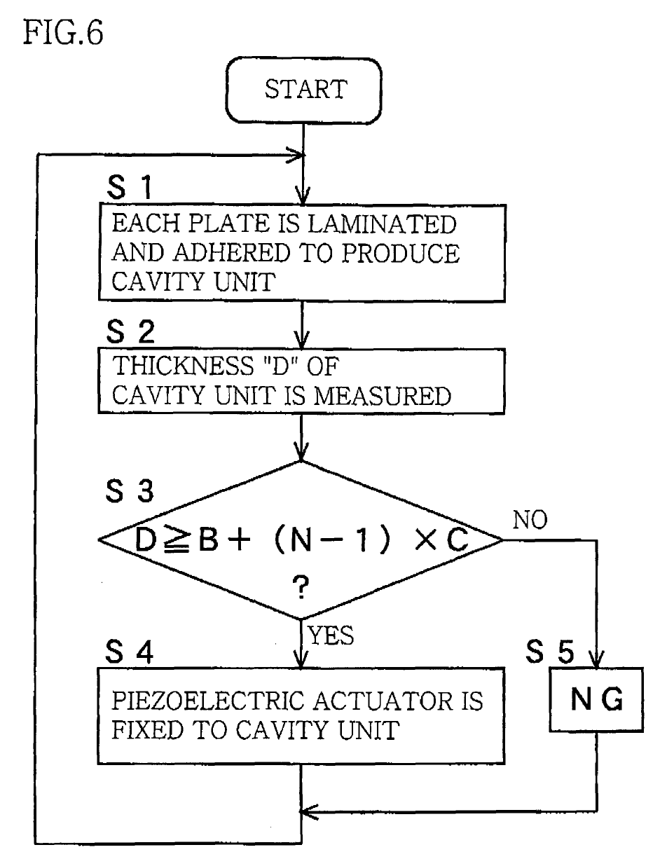

Next, there will be described a method for producing the ink-ejecting head 30, by reference to the drawings. FIG. 6 is a flow chart showing the method for producing the ink-ejecting head 30. In an adhering operation, the plate members are laminated with the adhesive layers each interposed between adjacent two of the plates. The laminated plate members and the adhesive layers are pressed by a pressing means such as a press machine and concurrently heated to harden the adhesive layers, whereby the laminated plate members are adhered to one another. Accordingly, the cavity unit 50 is produced (Step 1, abbreviated as “S1” hereinafter). In the adhering operation, the plate members may be adhered by being pressed and heated one by one, or the plate members may be adhered all together after a predetermined number of the plate members are laminated.

Subsequently, a thickness “D” of the cavity unit 50 produced in S1 is measured by a measuring means such as a laser measuring instrument (S2). Then, it is judged whether the thickness “D” measured in S2 is not less than a thickness (hereinafter, referred to as “a target thickness”) obtained beforehand by the formula: B+(N−1)×C (S3). Where the thickness “D” is not less than the target thickness (S3: YES), the piezoelectric actuator 40 is fixed to the cavity unit 50 (S4). Where the thickness “D” is less than the target thickness (S3: NO), the piezoelectric actuator 40 is not fixed to the cavity unit 50. In this case, the cavity unit 50 produced in S1 is judged as an NG product and removed from a producing process (S5).

As described above, the piezoelectric actuator 40 is fixed to the cavity unit 50 only where the measured thickness “D” of the cavity unit 50 is not less than the target thickness, thereby obviating a waste of the piezoelectric actuator 40 due to the insufficiency of the adhesive. Therefore, the yield rate of producing the ink-ejecting head 30 can be increased. Especially, since the printing test is performed after there have been produced, by lot unit, a number of the ink-ejecting heads 30 in each of which the piezoelectric actuator 40 and the drive circuit are fixed to the cavity unit 50, a considerable number of the ink-ejecting heads 30 are recognized as the defective products if the poor adhering is found out or detected at the time when the printing test is performed. However, according to the above-described method for producing the ink-ejecting head 30, the insufficiency of the adhesive can be found out or detected before one lot of the ink-ejecting head 30 has been produced, thereby further increasing the yield rate of producing the ink-ejecting head 30.

In the method for producing the ink-ejecting head 30 according to the present invention, the following method may be adopted as an alternative of the above-described method. Before all of the plate members constituting the cavity unit 50 are laminated and adhered in S1, a total thickness of the multilayered body (which is constituted by the plates that have been laminated) is measured at a time when a predetermined number of the plate members are laminated and adhered (S2). That is, the total thickness of the multilayered body as a part of the cavity unit 50 is measured. Then, the total thickness measured in S2 is compared with a target thickness corresponding to the multilayered body (S3). Where the total thickness is not less than the target thickness (S3: YES), the rest of the plate member/members to be laminated is/are superposed on and adhered to the above-described multilayered body, and the piezoelectric actuator 40 is fixed to the cavity unit 50 (S4). Where the total thickness is less than the target thickness (S3: NO), the rest of the plate member/members to be laminated is/are not superposed on and adhered to the multilayered body. In this case, the above-described multilayered body is judged as an NG product and removed from the producing process (S5).

According to the above-described method for producing the ink-ejecting head 30, it can be judged that the insufficiency of the adhesive has been occurred even in the middle of the producing process in which the plates constituting the cavity unit 50 are laminated, thereby making it possible to realize the early detection of the insufficiency of the adhesive.

### Other Embodiments

In the above-described embodiment, there have been described methods for producing the liquid-ejecting head, for checking the quality thereof and for managing the thickness of the multilayered body thereof. However, it is to be understood that the present invention is not limited to the details of the embodiment illustrated hereinabove, but may be embodied with various changes without departing from the spirit of the present invention. For example, the present invention may be applied to following types of a liquid-ejecting head: (1) a liquid-ejecting head from which a liquid other than the ink is ejected; (2) a liquid-ejecting head using a specific one-color ink; (3) a liquid-ejecting head from which a liquid is ejected by using the pressure fluctuation caused by air bubbles generated in the liquid, owing to heat energy given to the liquid such as the ink; and (4) a liquid-ejecting head from which a liquid is ejected by using a displacement of a vibration plate caused by static electricity, and so on.

What is claimed is:

1. A method for managing a thickness of a multilayered body constituting a part of a liquid-ejecting head,
wherein the liquid-ejecting head includes; (a) a liquid-channel unit formed of a plurality of plate members which are laminated on each other with at least one adhesive layer each interposed between adjacent ones of the plurality of plate members, the liquid-channel unit including a liquid channel provided in an inside thereof and a nozzle provided in an outer surface thereof; and (b) an actuator fixed to the liquid-channel unit and operable to eject liquid droplets from the nozzle,
wherein the multilayered body constitutes at least a part of the liquid-channel unit, and includes a plurality of plate members which are at least a part of the plurality of plate members constituting the liquid-channel unit and at least one adhesive layer which is at least a part of the at least one adhesive layer constituting the liquid-channel unit, and
wherein the thickness of the multilayered body is managed so as to be not less than a sum of (i) a total thickness of the plurality of plate members included in the multilayered body and (ii) a product in which a reference thickness as a minimum required thickness of one of the at least one adhesive layer is multiplied by a number of the at least one adhesive layer included in the multilayered body.

2. A method for checking a quality of a liquid-ejecting head including: (a) a liquid-channel unit formed of a plurality of plate members which are laminated on each other with at least one adhesive layer each interposed between adjacent ones of the plurality of plate members, the liquid-channel unit including a liquid channel provided in an inside thereof and a nozzle provided in an outer surface thereof, and (b) an actuator fixed to the liquid-channel unit and operable to eject liquid droplets from the nozzle, the method comprising:
preparing a multilayered body which constitutes at least a part of the liquid-channel unit, and which includes a plurality of plate members that are at least a part of the plurality of plate members constituting the liquid-channel unit and at least one adhesive layer that is at least a part of the at least one adhesive layer constituting the liquid-channel unit; and
confirming that the thickness of the multilayered body is not less than a sum of (i) a total thickness of the plurality of plate members included in the multilayered body and (ii) a product in which a reference thickness as a minimum required thickness of one of the at least one adhesive layer is multiplied by a number of the at least one adhesive layer included in the multilayered body.

3. A method for producing a liquid-ejecting head including: (a) a liquid-channel unit formed of a plurality of plate members which are laminated on each other with at least one adhesive layer each interposed between adjacent ones of the plurality of plate members, the liquid-channel unit including a liquid channel provided in an inside thereof and a nozzle provided in an outer surface thereof, and (b) an actuator fixed to the liquid-channel unit and operable to eject liquid droplets from the nozzle, the method comprising:
forming a multilayered body which constitutes at least a part of the liquid-channel unit, and which includes a plurality of plate members that are at least a part of the plurality of plate members constituting the liquid-channel unit and at least one adhesive layer that is at least a part of the at least one adhesive layer constituting the liquid-channel unit;
measuring a thickness of the multilayered body; and
confirming that tie thickness of the multilayered body which has been measured is not less than a sum of (i) a total thickness of the plurality of plate members included in the multilayered body and (ii) a product in which a reference thickness as a minimum required thickness of one of the at least one adhesive layer is multiplied by a number of the at least one adhesive layer included in the multilayered body.

4. The method for producing the liquid-ejecting head according to claim 3, farther comprising:
fixing the actuator to the multilayered body which has been confirmed.
